(19) United States
(12) Patent Application Publication
(10) Pub. No.: US 2014/0131206 A1
(43) Pub. Date: May 15, 2014

(54) CAPACITIVE ELECTROKINETIC DEWATERING OF SUSPENSIONS AND SOILS

(71) Applicant: Azaroghly YAZDANBOD, Calgary (CA)

(72) Inventor: Azaroghly YAZDANBOD, Calgary (CA)

(21) Appl. No.: 14/079,148

(22) Filed: Nov. 13, 2013

Related U.S. Application Data
(60) Provisional application No. 61/725,742, filed on Nov. 13, 2012.

(51) Int. Cl. B01D 61/56; B01D 57/02

(52) U.S. Cl. CPC B01D 61/56; B01D 57/02
USPC 204/518; 204/553; 204/648; 204/627

(57) ABSTRACT

An apparatus and process for electrophoretic and electro-osmotic densification, decontamination and dewatering of suspensions includes the use of high electrical capacitance electrodes for capacitive generation of electric fields. Polarity reversals between the capacitor electrodes prevent faradic electrolysis and corrosion reactions at the electrodes, and water wettable, flexible linings for the electrodes, having drainage and filtering capabilities, can also be used as interceptor drains positioned adjacent and in full electric contact with the electrodes, as well as within the suspension as flow path dividers.

### CROSS REFERENCE TO RELATED APPLICATION

This application claims the benefit of U.S. Provisional Application No. 61/725,742, filed Nov. 13, 2012, which is incorporated herein in its entirety.

### FIELD OF THE INVENTION

The present invention generally relates to the use of electric double-layer capacitors for inducing capacitive electro-kinetic processes in saturated soils and suspensions. More specifically it relates to a process and apparatus to separate finely divided clay particles from aqueous suspensions thereof through capacitive electrophoresis and capacitive electro-migration, and dewatering of soils and suspensions through capacitive electro-osmosis.

### BACKGROUND OF THE INVENTION

At the present time some 170 square kilometers of Alberta, Canada is covered by ponds filled with oil sands tailings. Oil sands tailings are a waste by-product from the oil sands extraction processes used in mining operations. Oil sands tailings ponds are used as a settling basin/storage container for suspensions of a mixture of water, sand, silt, clay, contaminants and unrecovered hydrocarbons. Once in the pond, the sand quickly sinks to the bottom, and the water from the top few meters is recycled. Tailings ponds present a number of challenges. Seepage into ground water can occur. The middle layer, a mixture of clay and water called fine tailings, takes a long time to settle and solidify. Even after many years tailings ponds will still have the consistency of yogurt, and it can take up to 30 years to sufficiently separate and dry out so that they can be capped. The remaining water, because of the extraction process, contains concentrations of a number of chemicals and hydrocarbons that are toxic to fish and pose a risk to waterfowl.

Despite many years of research, and millions of dollars of expenditures, no clear cut solution for treatment, densification and eventually capping of these open ponds has been found. The industry continues to develop better technologies and approaches to tailings management in order to reduce the environmental impact. Oil sands operators are currently investing more than $1 billion in tailings-reduction technology. Several technologies have been implemented and more are being tested to reduce the volume of fine tailings and speed their rate of solidification.

Most solid materials demonstrate an electric charge when suspended as fine particles in a liquid. By applying a direct current (DC) electric field between two electrodes immersed in the particle suspension, the particles are caused to travel toward one of the electrodes and form a deposit thereon. This travelling of solid particles through a liquid due to the application of electric current is referred to in the art as electrophoresis. When under the influence of a DC potential, water or other liquid medium is caused to migrate through a stationary porous media, such as soil, toward a charged electrode. This phenomenon is referred to in the art as electro-osmosis. Both electrophoresis and electro-osmosis have been applied to the separation of clays and water from aqueous suspensions thereof. When applied to aqueous clay suspensions, electrophoresis is generally used to effect the deposition of the suspended clay material on a charged electrode, whereas electro-osmosis functions as an aid in consolidating and concentrating typically denser suspensions including the electrophoretically deposited clay, by removal of the entrained water from the deposit.

The direction of an electric field is the direction of the movement of a positive charge placed in the electric field. If the suspended particles are positively charged, the direction of electro-osmotic fluid movement will be from cathode towards anode. Throughout this document the discussions are directed to negatively charged particles in suspension, such as normal clays, but the principals discussed apply in reverse direction to positively charged particles in suspensions equally.

Once an electric field is established across a clay suspension, the clay particles move in the opposite direction of the electric field until they encounter a barrier such as a filter or the anode electrode. As clay particles begin to approach each other, the positively charged particle ends attract to the negatively charged clay particle surfaces and form the well-known flocculated soil structure of clays, resulting in their observed cohesive behavior. Once the soil structure is established, further application of the electric field will result in the electro-osmotic flow of water from within the soil pores. This fluid flow, in the presence of clays will be in the opposite direction to electrophoresis particle flow. This is referred to as electro-osmotic dewatering.

While well known and beneficial, there are practical drawbacks to the use of electrophoretic and electro-osmotic dewatering systems. For example, when the electrodes are polarized, there is a migration of water molecules towards the cathode, but after the system has been in operation for a time the electrodes become surrounded by or covered with coherent films of gas, formed by electrochemical reactions at the electrode surfaces. These films have a high electrical resistance, leading to deterioration of the electrical characteristics of the system and lowered system efficiency. A similar problem arises from the fact that the anodes of the system are subject to a high degree of electrolytic corrosion. Where electrodes are installed specifically for dewatering, this corrosion results initially in reduced system efficiency, and, eventually, in complete electrical discontinuity at the electrode. Thus, it becomes necessary to discontinue use of the system or replace the electrodes.

Accumulated gases present another problem in existing electro-osmotic dewatering systems. As noted above, passage of current through water can result in electrolysis of the water. This can generate hydrogen gas at the cathode and oxygen gas at the anode. Depending on the composition of the electrode material and the ions present in the pore fluid (water), other gases such as chlorine might also be produced. Electrode reactions at electrode faces also lead to consumption of electric energy and corrosion of electrodes, in turn increasing the energy waste at electrodes. In addition, electrochemical reactions at electrodes lead to the splitting of water molecules and the generation of hydroxide ions (OH⁻) at cathode which move towards the anode and hydrogen ions (H⁺) at anode which move towards the cathode. This means that an acidic (H⁺) front moves towards the cathode and a basic (OH⁻) front move towards the anode. These ions have the potential of changing the PH of the pore fluid and also reacting with other ions present in the pore fluid. In the case of metallic ions, such reactions could result in the formation of low solubility or precipitating metal hydroxides that prevent their further migration through and their removal from the soil body. Further, and depending on the composition of electrodes, electrode reactions could also lead to corrosion of electrodes and release of their elemental constituents in ionic form into the suspension or the soil body, further complicating and hampering the intended and beneficial decontamination effects and particle movement or dewatering processes.

The corrosion potential of electrodes and means of their remediation have been addressed in the prior art. U.S. Pat. No. 5,725,752 to Sunderland et al. discloses that a wrapping of conductive carbon felt around and in contact with a metallic conductor could be used to reduce electrode corrosion in soil decontamination applications. The high porosity of these carbon felts are also used as means of introducing buffering or neutralizing solutions to the vicinity of the electrodes used. A similar approach is also proposed in the U.S. Pat. No. 6,203,682 to Hodko, which discloses the introduction of neutralizing solutions to the vicinity of the electrodes, which are wrapped in a high permeability cover layer of perforated plastic tubing and in turn surrounded by a layer of low permeability clay or ceramic, for use in inducing electro-osmotic flow in high permeability sandy soils. US Patent Pub. No. 2007/0267355 to Jones et al discloses an apparatus and method for dewatering a particulate/liquid dispersion or suspension, wherein the electrodes comprise a textile or other synthetic material associated with a conductor and do not corrode readily. While these disclosures may be useful for their intended purposes, the issue of electrode corrosion with electro-kinetic dewatering systems is still a problem.

The rates of electrophoretic and electro-osmotic flows are directly proportional to the intensity of the established electric field. This means that with higher electric field intensity (electric potential difference per unit distance) there will be higher electrokinetic flow rates. For ideal, non-capacitive electrodes, herein defined as electrodes that could affect electrochemical reactions without energy dissipation and without an interfacial potential drop, the intensities of the electric fields are directly proportional to the potential difference applied between a given anode and a given cathode and are inversely proportional to the distance between them. Thus, for a given geometric arrangement of such ideal electrodes, the higher the potential difference between counter electrodes, the higher the electrokinetic flow rate will be. For real conditions in which electrodes are not ideal, generation of electric fields are limited by electrolysis occurring at the electrodes. Thus, while the effect of electrophoresis and electro-osmosis on clay separation has long been known, they are not commercially successful by the present day art.

The net amount of water electro-osmotically removed from a volume of soil or suspension is equal to the difference between the amount of water removed at cathode and the amount of water entering the soil at the anode. Therefore, during applications of electro-osmosis for the dewatering of soils, consolidation of soils near the anodes is more pronounced than near the cathodes. However, with removal of water from the vicinity of the anodes and, due to the resulting consolidation and volume reduction in the soils around the anodes, the contact between the soils and the electrode is reduced, which increases the electric resistance between the electrode and the soil or suspension, in turn leading to reduced electric current flow at constant voltage or the need to increase the applied potential to maintain a constant current. However, if water is allowed or facilitated to enter to the vicinity of the anodes, the net amount of water removed from the soil or suspension is reduced. Indeed, in decontamination applications such phenomena are used to replace the pore fluid in soils, as described in U.S. Pat. No. 5,074,986 to Probstein et al., disclosing that a purging liquid introduced at the anode (referred to as source electrode) could be used to facilitate the removal of contaminants.

In classical applications of electro-osmosis for dewatering and/or decontamination of soils, anodes are chosen to be solid metals and are placed in contact with the soil surrounding them, while cathodes are typically perforated or made of wires and are placed in open holes to allow for collection and discharge of water entering them. This is typically referred to as a closed anode and open cathode condition. U.S. Pat. No. 5,584,980 to Griffith et al postulates arranging a plurality of adjacent electrode “panels” in rows, placed directly into the soil in situ. The electrode panels include “flowable treatment media” generally made of sand and gravel particles surrounded by a geotextile filter layer. These electrode panels are used for adding or removing liquids to and from the vicinity of the electrodes and maintaining electrical contact with the electrodes and the suspension/soil. Griffith et al also propose the use of treatment panels that are very similar to electrode panels. Removal of water from the treatment panels is accomplished by installing a vertical perforated pipe on one side of the panel and pumping the water out. These treatment panels can also be viewed as means for removal of water or contaminants and as such function as interceptor drains. In this use they shorten the path the water or the contaminants need to travel before they are removed. The previously referenced electrode panels are interceptor drains as well that function as means of removing or adding water to the vicinity of the electrodes and also as means for maintaining good electrical contact between the electrode and the suspension/soil.

In light of the above, it would be beneficial for the electrodes of a dewatering apparatus to maintain reliable electric contact with a saturated soil suspension without the need for adding water or other treated liquids at the vicinity of the electrodes. It would also be beneficial to facilitate electrokinetic particle movement and electro-osmotic soil dewatering within saturated soil suspensions without having detrimental electrolysis by-products and side reactions at the electrodes. It would also be useful to provide interceptor drains for capacitive electro-kinetic dewatering devices for shorter flow paths that have low electric resistance for energy savings. It would also be beneficial to provide a means for transforming the usually in situ dewatering and decontamination operations of suspensions and saturated soils to a plant-based operation, thereby allowing the design parameters to be optimized and providing a high volume, low cost means for treatment of particulate/liquid suspensions in general, and oil sands tailings in particular.

### SUMMARY OF THE INVENTION

Accordingly, the present invention involves the use of high electric capacitance electrodes as a means of generating the electric fields required for concentrating, decontaminating and dewatering particulate/liquid dispersions, suspensions or saturated soils. Further, the electrode covers and interceptor drains disclosed herein provide a means for transforming the usually in situ dewatering and decontamination operations of suspensions and saturated soils to a plant-based operation, wherein the design parameters and requirements can be optimized.

One aspect of the invention provides a method for decontamination and densification of and fluid extraction from a suspension comprising a particulate/liquid dispersion through capacitive electrophoresis and capacitive electro-osmosis processes, the method comprising: (a) receiving an untreated suspension in an insulated container; (b) providing at least one pair of high electric capacitance electrodes spaced apart within the container, wherein the electrodes act as electric double layer capacitors when a potential difference is applied between them; (c) applying a direct current (DC) potential difference between the capacitor electrodes to generate an electric field across the suspension to drive capacitive electro-kinetic dewatering, wherein the electric potential developed is less than the potential needed to cause occurrence of faradic reactions at the electrodes; (d) reversing the polarity of the DC potential applied to the electrodes upon approach of the initiation of faradic reactions, resulting in the reversal of the electric field direction between electrodes; and (e) removing fluid from the container with at least one outlet drain line.

Another aspect of the invention provides an apparatus for decontamination and densification of and fluid extraction from an untreated suspension comprising a particulate/liquid dispersion through capacitive electrophoresis and capacitive electro-osmosis processes, the apparatus comprising: (a) an insulated container to receive and contain the suspension; (b) at least one pair of high electric capacitance electrodes spaced apart within the container, wherein the electrodes act as electric double layer capacitors to generate an electric field when applying a potential difference there across and hence across the suspension to drive capacitive electro-kinetic dewatering; and (c) at least one outlet drain line to enable removal of fluid from the container.

Another aspect of the invention provides an apparatus for capacitive electrophoretic and capacitive electro-osmotic removal of fluids from an electro-active suspension, the apparatus comprising: (a) an insulated container to receive and contain the suspension; (b) at least one pair of high electric capacitance electrodes spaced apart within the container, wherein the high electric capacitance electrodes act as electric double layer capacitors to generate an electric field when applying a potential difference there across and hence across the suspension to drive capacitive electro-kinetic dewatering; (c) at least one outlet drain line to enable removal of fluid from the container; (d) at least one interceptor drain comprising a water wettable, flexible fabric with drainage and filtering capability and the capability to pass electric currents when wet, wherein the at least one interceptor drain is positioned between the electrodes and within the suspension to allow for drainage of fluid entering the interceptor drain while also allowing for passage of electricity through the interceptor drain and across the suspension; (e) a direct current (DC) power supply capable of polarity reversal and connected to the electrodes to generate electric field between the electrodes in one direction or the other; and (f) a cover for each of the electrodes, each of the covers comprising a water wettable, flexible fabric with drainage and filtering capability and the capability to pass electric currents when wet, wherein the covers facilitate fluid removal from the location of the electrodes without loss of electric contact between the electrodes and the suspension.

The nature and advantages of the present invention will be more fully appreciated from the following drawings, detailed description and claims.

### BRIEF DESCRIPTION OF THE DRAWINGS

FIG. 1 represents a test setup in which the scientific basis and workability of various aspects of this invention were tested and verified.

FIG. 2 presents a side view of a preferred embodiment of this invention.

FIG. 3 presents a top view cross section of the same preferred embodiment presented on FIG. 2.

### DETAILED DESCRIPTION OF THE INVENTION

### Definitions

As defined herein, the terms “ion” or “ions” refer to hydrated ions as they exist in electrolyte solutions.

The terms “active electrode” and “counter electrode” can also mean “anode” and “cathode”, respectively, depending on their charge.

The term “plastic container” means an insulated container that is lined by non-conductive materials such as plastic.

The terms “suspension” or “slurry” refer in general to electro-active material such as aqueous suspensions of fine mineral solids, particulate/liquid dispersions or suspensions, or low-density mixtures of suspended loads of surface-charged particles in a fluid, and in particular to clay-water suspensions such as Mature Fine Tailings (MFT), dispersions or suspensions of inorganic particles that are a by-product of mining, manufacturing or other industrial processes, or oil sands tailings sludge, irrespective of the existence of other organic or inorganic constituents in the mix.

The present invention provides an improved system and method for treating particulate/liquid dispersions or suspensions, including those found in oil sands tailings, by incorporating the use of high electric capacitance electrodes. Early developments in carbonaceous high electric capacitance electrodes as capacitor plate materials are disclosed, for example, in U.S. Pat. No. 5,789,338 to Kaschmitter, which is incorporated herein in its entirety. The invention can also employ thin flexible, water wettable ion-conducting filters as linings or covers for the electrodes, as well as interceptor drains made of the same flexible, water wettable material for collecting and removing water from the suspension between the electrodes. These water wetable fabrics or layers are typically made up of non-woven geotextiles that in addition to being flexible also possess such fine texture as to retain water on their inner porosity to allow passage of ions under the influence of electric fields combined with high hydraulic permeability.

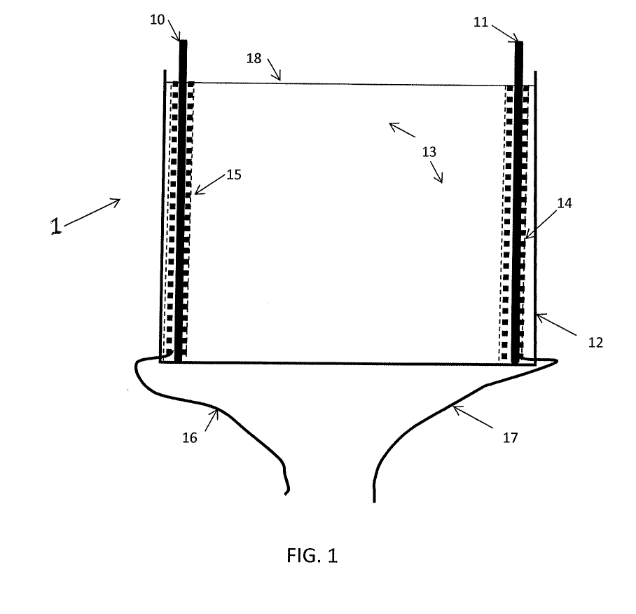

With reference to FIG. 1, one embodiment of an apparatus 1 of the present invention involves the use of high electric capacitance electrodes 10, 11, typically in the form of electric double-layer capacitors (EDLCs), as a means of generating the electric fields required for concentrating, decontaminating and dewatering particulate/liquid suspensions or saturated soils 13. EDLCs are employed in the saturated soils to cause electrokinetic flow in the form of electrophoretic and/or electro-osmotic flow. In order to avoid/prevent electrolysis reactions and/or corrosion at the electrodes, the polarity of the applied potentials to the capacitor electrodes 10, 11 can be reversed. In contrast, polarity reversals in other related prior art devices are not related to the use of EDLCs and the avoidance of corrosion, but are directed to dislodging the electrophoretically deposited material from electrode surfaces or for cleaning out filters that might have been clogged (e.g., see U.S. Pat. No. 6,871,744 to Miller et al, or US Pub. No. 2012/0292186 to Adamson).

As illustrated in FIG. 1, the invention can use thin, ion conducting filters as linings or covers 14, 15 having high hydraulic drainage properties to surround and/or cover the high electric capacitance electrodes 10, 11. These covers 14, 15 allow for reliable electric contact between the electrodes and the suspension 13. Combined with the capability of such filters to drain water gravitationally, the covers 14, 15 allow for separate electric (ionic) and fluid (electro-osmotic) flow with minimal electrical resistance. Drain line outlets 16, 17 facilitate the removal of fluids from the electrode covers 14, 15, and can either be non-flexible plastic tubing or flexible tubing capable of fluid conductance.

Thus, looking at the apparatus 1 of FIG. 1, an insulated plastic container 12 includes high electric capacitance electrodes 10, 11 having the capability of electrical double layer capacitors (EDLCs), wherein the capacitor electrodes 10, 11 are connected to the opposite poles of a direct current electric power supply (not shown) to establish an electric field between them. If, as a non-limiting example, suspension 13 is a suspension of normal clays in which the individual clay particles have negatively charged surfaces, the electric field will cause the movement of these negatively charged clay particles in this suspension 13 in the opposite direction of the electric field (from cathode to anode) and their accumulation on filter/drainage linings 14, 15 on the side facing the particle flow direction. Continued electrophoretic flow of the suspension load (such as clays) will lead to their relative densification and precipitation on the linings 14, 15. Also, the generated electric field will cause the flow of ions through the covers 14, 15.

With continued application of the potential difference between electrodes 10 and 11, gradually the potential of ions absorbed at each electrode begin to reach a level that could cause faradic reactions (i.e. electrolysis reactions), potentially leading to generation of gases. This would be signified by the easily measurable electric potential difference between each electrode and the solution directly adjacent to it by such means as connecting one pole of a potentiometer to the electrode while the other pole is connected to the liquid adjacent to the electrode through an inert electrode. When an electrode is serving as an anode in a water-based electrolyte solution, the limiting potential difference is about 1.23 Volts, and in the case of a cathode it is about 0.83 Volts. In the present invention, in order to avoid any faradic reactions, the polarity of potentials applied to opposing electrodes is reversed before such limiting potentials are approached or achieved. The potentials used as the criteria for polarity reversals can be chosen based on various operational requirements and optimum use of the existing capacitances. Previous attempts at introducing electrokinetic processes to industrial dewatering technology have frequently failed due to the rapid deterioration of the electrodes through corrosion and due to other unwanted electrochemical effects of these electrode reactions.

Upon reversal of the polarity of the electric potentials applied between electrodes 10 and 11, the direction of the electric field between these electrodes is also reversed. This reversal of direction of the electric field will now cause the flow of the suspension load in the opposite direction and their accumulation on the opposite facing of linings 14, 15 and also a tendency for their removal and return to the suspension from the linings where they had accumulated before. The degree of their removal from the lining facing will be governed by electro-osmotic flow intensity, now developed within these flocculated solids.

Indeed, there is a transition between electrophoretic and electro-osmotic flow within a given body of electro-active material, such as in aqueous suspensions of clays. With the application of an electric field, coulomb forces are exerted on the negatively charged clay particles and the double layer surrounding each clay particle. The strength of an electrical charge on a clay particle, or its degree of electronegativity, is often quantified in terms of its Zeta Potential. The Zeta Potential is usually defined as the electrical potential at the junction between the fixed and mobile parts of the electrical double layer. It is dependent on the pH of the surrounding liquid and is also influenced by the valence of the ions present. As the association between clay surfaces and high valence cations increases, the zeta potential decreases. If the particle is suspended in a solution, the coulomb forces acting on such negatively charged particles cause them to move in the opposite direction of the applied electric field (i.e. electrophoresis occurs). The two key phenomena for electrokinetic dewatering are electrophoresis and electro-osmosis. As the particles move and are brought close enough to each other to prevent their further movement, then the coulomb forces acting on the double layer will result in the movement of the double layers and the pore fluids adjacent to them, causing electro-osmotic flow.

Once the potential differences between each of the electrodes and the fluid directly adjacent to them approach the previously noted values to initiate faradic reactions again, the polarity of the potentials applied between electrodes would have to be reversed again, and these cycles are repeated until a desired level of densification of the medium 13 is reached. During all these cycles, excess fluids entering the linings 14, 15 (depending on the direction of the electro-osmotic flow) will have to be removed by the outlet drain lines 16, 17 of the fluid collection system (gravitationally drained or pumped out). Confined groundwater is usually under pressure because of the weight of the overburden and the hydrostatic head. If a well penetrates the confining layer, water will rise to this level, the piezometric level, the artesian equivalent of the water table. If the piezometric level is above ground level, the well discharges as a flowing well, artesian well, or a spring. In this invention the flow of electricity is maintained even when the piezometric level in the electrode covers and in the interceptor drains are well below the piezometric level within the suspension/soil.

If the piezometric level within the linings 14, 15, which are the filter/drainage layers, remains at the same level as the suspension, the requirement of flow continuity in any time span will require that the flow of fluids into the zones adjacent to the anode and the cathode to be the same. That is, net extraction of fluids from the suspension via electro-osmosis, irrespective of the use of classical or capacitive electrodes, for establishment of the electric fields will require that the amount of fluid (water) removed from the location of cathode to be more than the amount of fluid entering to the location of the anode.

When two conductive electrodes are placed in an electrolyte and a direct current (DC) potential is established between them through connecting them each to one of the opposing poles of a DC electric power supply, an electric field is established between these two electrodes. If these electrodes are of low electric capacitance such as in the case of metallic electrodes, the available capacitance fills up rapidly and continued establishment of the electric field between them will be subject to occurrence of faradic reactions at electrode facings. However, if the electrodes possess high electric capacitances, such as in the case of composite carbon aerogel electrodes, oppositely charged ions with respect to the charge placed between electrodes are absorbed by each electrode and similarly charged ions with respect to the charge placed on the electrode are repulsed therefrom. Therefore, positive ions from within the electrolyte will tend to flow from the anode towards the cathode, and negative ions from within the electrolyte will tend to flow from the cathode towards the anode.

Once again with reference to FIG. 1, it is noted that if the outlet drain lines 16, 17 are opened, and the piezometric level (i.e. water level) is allowed to drop, then the non-woven, felt-like fabric material of linings/covers 14, 15 remain in contact with their respective electrodes 10, 11 and the suspension 13, allowing for and facilitating the flow of electricity in the form of ion flow between the electrodes and the suspension, while any fluid (water) entering therein is drained. Indeed, the existence of water wettable, flexible linings/covers 14, 15 with drainage and filtering capability allow for continuous electrical contact between electrodes 10, 11 and the suspension 13 being treated. This continuous contact continues as long as the deformations of the linings 14 and 15 caused by the hydrostatic load of the suspension can compensate for any volume changes therein, and can allow for the maintenance of electric contact between the electrode and the lining, and the lining and the suspension.

Another way of looking at such use of water wettable, flexible layers with drainage and filtering capacity is separation of the electric flow field from the fluid flow field. Within the soil or suspension 13, the electric field will be in the same direction as the electro-osmotic flow and in the opposite direction of the electrophoretic flow. However, in the vicinity of the electrodes 10, 11 and within the water wettable, flexible cover layers 14, 15 with drainage and filtering capabilities, the electric field will be towards or away from the electrode (depending on the polarity of the electrode) and the fluid flow field will be towards the drainage exit. This way the two flow fields are separated.

To explain the scientific basis of this invention, some basics of capacitor science need to be reviewed and highlighted. A conventional electric capacitor is an electric energy storage device made up of two electrically conductive plates that function on the basis of removal or placement of electrons from one conductive plate, resulting in the reverse phenomena of placement or removal of electrons from the other conductive plate of the capacitor, by the action of the electric field generated by the charge removed or placed on the first plate. This charge separation leads to a potential difference between capacitor plates and storage of electric energy by the capacitor. The electric potential, the electric charge and the electric energy stored in capacitors can then be used when capacitors are used in electric circuits.

Capacitance (C) of a capacitor in units of Farad is defined as the ratio of the amount of charge (Q) in units of Coulomb placed on or removed from each of capacitor plates, to the potential difference (V) in units of Volts between capacitor plates, or: C=Q/V. This electrical capacitance is a function of capacitor geometry and plate material and the permittivity of the material between the two capacitor plates. Capacitance increases with larger plate sizes, smaller distance between plates, higher permittivity of the material between plates and the use of higher surface area plate materials. In addition to the effect on increasing the permittivity, the choice of the dielectric material placed between the capacitors plates also set the limit for the maximum potential difference between plates as it relates to sparking which is electric discharging between capacitor plates or the breakdown of the dielectric between the plates.

The amount of energy stored in a capacitor is directly proportional to the amount of charge and the potential difference between plates. If the energy stored in a capacitor is designated as (U) in units of Joule, then: U=0.5*Q*V. The parameters and units are as defined earlier. Further it is noted that when two capacitors with capacities “C1” and “C2” are placed in series, the equivalent capacitance, or “Ceq” of the two connected capacitors, is defined by: 1/Ceq=1/C1+1/C2. This equation shows that when two capacitors are placed in series, the equivalent capacitance is effectively controlled by the capacitance of the capacitor with lower capacitance. Further, as the amount of charge placed on two capacitors in series (“q”) are equal, the potential difference between the plates of such individual capacitors denoted as “V1” and “V2” are defined as V1=q/C1 and V2=q/C2. Therefore, V1/V2=C2/C1.

The total potential difference across the two capacitors connected in series is herein denoted as V is: V=V1+V2. The above equations clearly indicate that when a capacitor with a very large capacitance is placed in series with another capacitor with very small capacitance, most of the potential difference applied across the two capacitors will occur across the capacitor with smaller capacitance.

Further, a relatively new concept in capacitors has emerged, and is typically referred to as super-capacitors, electrochemical capacitors, or electric double-layer capacitors (EDLC), which all refer to the same thing. Much attention is being paid to such capacitors as a next generation energy device together with secondary insulated plastic containers. The EDLC is an energy storage device using a pair of charge layers (electrode layers) having a different polarity. The EDLC may perform continuous electric charge and discharge and has higher energy efficiency and output and greater durability and stability than general capacitors. A basic structure of the EDLC includes two electrodes, an electrolyte, and a separator. The electrode plates are usually made up of high surface area material incorporating such material as activated carbon, carbon aerogels or carbon aerogel composites. Carbon aerogels are electrically conductive and porous material having a very large surface area and a high electrical capacitance. The capacitances of EDLCs are several orders of magnitudes larger than regular capacitors that use metallic plates and insulating dielectrics.

The increase in the electric capacitance of EDLCs is thought to be the result of formation of electric double layers, which are specific concentration of ions on and at very close proximity to each of the high surface area conductive capacitor plates. Thus, a charged EDLC includes two internal capacitors placed in series. In each of these internal capacitors, one capacitor plate is made up of a charged, conductive, high surface area plate and the other is made up of concentration of ions of opposite polarity in comparison to the charge on the high surface area plate. The high capacitances of EDLCs are the result of extremely small separation between the charged capacitor plates of the aforementioned internal capacitors.

Therefore, if there are two electrodes, as shown in FIG. 1, and there are electrode covers 14, 15 made up of water wettable, flexible material with drainage and filtering capabilities, such as sheets of felt like non-woven fabrics (non-woven geotextile), examples of which are noted in the tests and the preferred embodiments, and if the soil is more like a suspension of solids, the following phenomena can be observed: (1) electrophoretic flow of particles occurs towards the anode, with their accumulation on the electrode cover and extending in the bulk of the soil; (2) after sufficient densification there will be an electro-osmotic flow within the accumulated material with the consequent flow of the liquid into the outlet drains; (3) within the water wettable, flexible electrode covers there will be sufficient liquid present on their inner surfaces such that there is transfer of ions between the electrodes and the suspension with no electrophoretic and no electro-osmotic flows. Ions will move through the wetted surfaces from one side to the other. This will allow for separation of electric flow field from the fluid flow field and will therefore improve the efficiency of the dewatering system by increasing the net liquid output; (4) water entering the outlet drains can be gravitationally drained or mechanically pumped or vacuumed out; (5) by reversing the polarity of the potentials applied to the electrodes resulting in reversal of the direction of the electric field between the electrodes, the same process of water moving into the outlet drain line and accumulation of the particles towards the other drain will occur; and (6) by use of high electric capacitance electrodes, all detrimental faradic effects such as oxidation reactions at anodes and reduction reactions at cathodes leading to corrosion of electrodes, generation of gases at electrodes, and chemical reactions within the soil or suspension caused by PH changes also caused by electrode reactions, all leading to reduced contact between the electrodes and the surrounding soils and increased electrical resistance, will be eliminated.

It is worth noting that the rate of charge transfer to a capacitor is governed by capacitor time constant (T) in units of time (seconds), which is equal to the product of capacitance (C) in units of Farads and electric resistance (R) of the equivalent circuit in units of Ohms. When a voltage is applied to a capacitor, it takes some amount of time for the voltage to increase in a curve that follows a mathematically “exponential” law to its maximum value, after which, the voltage will remain at this “steady state” value until there is some other external change to cause a change in voltage. An amount of time equal to several time constants is typically required to practically fill up a capacitor. As a non-limiting example, if the time constant is approximately 3 minutes, the time required to fill the capacitors will be approximately 10 minutes (or about 3 time constants), which is a reasonable value for timing of polarity reversals. It is further noted that for practical applications, the system should be designed such that the time required to sufficiently fill the capacitors to potential levels that are less than the limits for initiation of faradic electrode reactions would be at least several minutes.

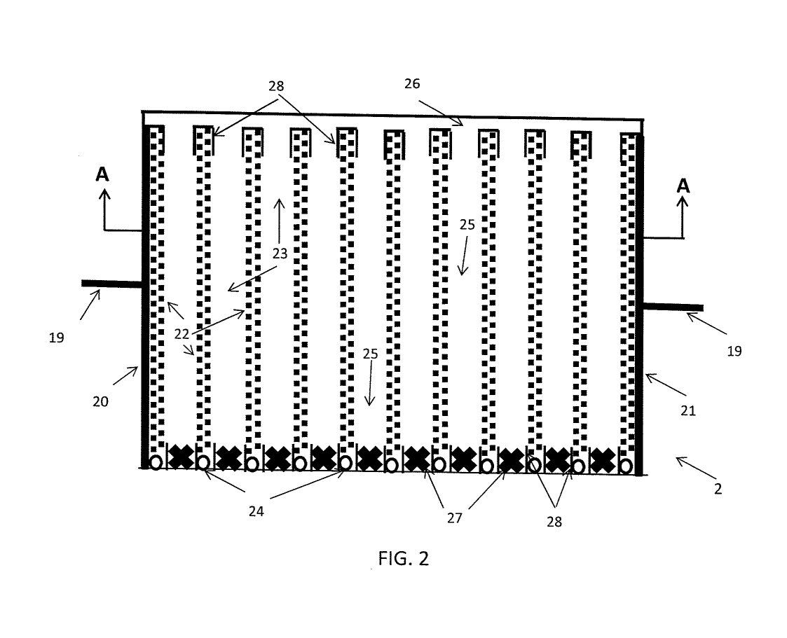

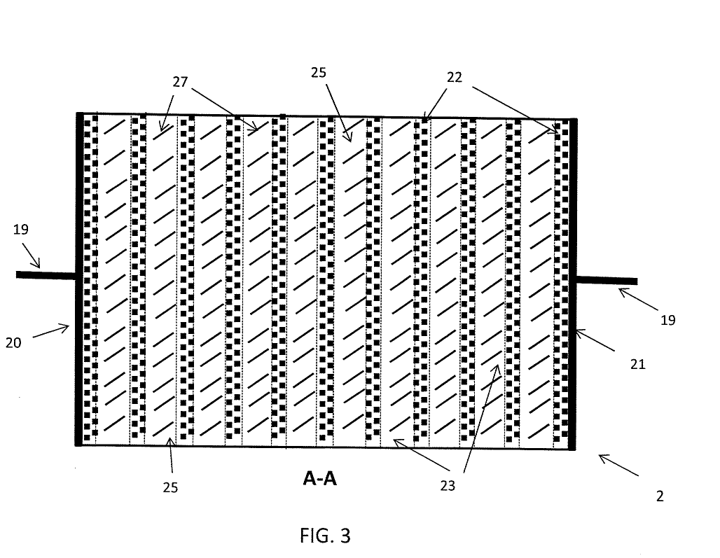

Another (preferred) embodiment of this invention is presented in FIGS. 2 and 3, which show an apparatus 2 for removal of water or similar fluids from a suspension in which two electrodes 20, 21 are connected to opposite poles of direct current electric energy supply source capable of polarity reversal (not shown) through leads 19. Apparatus 2 is also equipped with a plurality of interceptor drains 22 made up of material capable of also acting as filters with respect to the suspension 23. Each of the electrodes 20 and 21 are fully covered by one drainage/filter layer 22 which serves as a cover for the electrodes as described above for FIG. 1. Any water or fluid drained through layers 22 are allowed to exit the device 2 through outlet drain lines 24, which could in turn be connected to perforated pipes (not shown) each placed at the bottom of each drainage/filter layer, to facilitate flow of drained fluids to the outside. Like the outlet drain lines 16, 17 in FIG. 1, the outlet drain lines 24 in FIGS. 2 and 3 can be either rigid or flexible. Suspension 23 flows into device 2 and passages 25 between drainage/filter layers 22 through an inlet at the top (not shown) connected to a cavity 26 that distributes the suspension 23 in the passages 25. Helical screws 27 are also optionally positioned at the base of each of passages 25, and when operated cause the flow of the treated suspensions to the outside of device 2. Necessary means for conveyance of drained fluids and treated suspensions away from device 2 in the form of air gap equipped pipes or channels are envisioned, but are not shown. The air gaps are included to prevent short circuiting between various flow channels. Plastic framing 28 is used to secure and hold the drainage/filter layers in place.

In practice, and because flow of electricity between the electrodes and within the suspensions in passages 25 follows the Ohm's law, energy usage will be lower for smaller thicknesses. Therefore, these passages 25 should be as thin as possible, compatible with their other function for conveyance of the suspension from top to bottom of these passages. Here helical screws 27 are envisioned as a means of moving the treated material out of device 2. Alternatively, other means such as moving blades, moving downward in the passages 25, could be used for the same purpose or in conjunction with helical screws 27 for moving the treated material out of the insulated plastic container. Another alternative could be the use of pressure to cause the flow of the densified suspension downward. Interceptor drains 22 are also envisioned to act as filters with respect to the particles constituting the slurry or suspension 23. Here the requirement is for these water wettable, flexible linings and drainage materials to not only be able to convey the ions responsible for electric flow in both directions, but to also facilitate effective drainage of any water entering them electro-osmotically or gravitationally or under an applied pressure.

Here it should be noted that the situation at each covered capacitor electrode, as discussed above for FIG. 1 in terms of separation of electric and hydraulic flow fields, will be very similar to the situation at any interceptor drain 22. That is, ions move independently of the flow of water entering within the interceptor drains.

In practice, once an electric field is established between the electrodes 20 and 21 by connecting them to the opposite poles of a direct current electric energy source, flow of ions through the suspension 23 and interceptor drains/electrode covers 22 will cause electrophoretic concentration of the particles by their movement towards the anode, to be followed by their drainage by electro-osmosis. Water moving laterally towards the drains 22 enters them and is drained out, causing further densification of the slurry 23. Once the electrical potential between either of the electrodes 20, 21 and the suspension 23 directly adjacent to each electrode approaches the level for initiation of faradic reactions, the polarity of the applied potentials are reversed and the processes are all repeated in the opposite direction. Both cycles are repeated while the slurry flows through the device, in batch or continuously.

The electrode covers and the interceptor drains as disclosed herein, both of which are listed as element 22 in FIGS. 2 and 3, differ from those used in related prior art devices, in that they are thin and conduct ions even when drained (emptied from water but still wet), they do not use sand and gravel, and they can be flexible to deform under the hydrostatic pressure of the suspension, thus being able to maintain reliable contact and low electric resistance with the capacitor electrodes 20, 21. Further, the electrode covers are typically employed in an isolated insulated plastic container, and not in situ, and therefore can be drained gravitationally from the drain outlets 24 at the base of the container. The interceptor drains 22 differ from drains of related prior art devices because their use with insulated plastic containers allows them to be placed very close to one another and to the electrodes 20, 21, such that in operation there is a shortened flow path. This reduces energy consumption. The interceptor drains are also a means of separating the electric and hydraulic flow fields.

The apparatus 2 of FIGS. 2 and 3 typically comprises a closed containment means, into which the suspension material 23 may be fed for batch or continuous processing. A typical container can have dimensions of about 5 meters in height, about 2 meters in width, and a length of about 4 meters. The interceptor drains can be about 3 mm thick and can be spaced about 15 mm apart from center line to center line. Therefore, some 260 individual interceptor drains (each 5 meters tall and 2 meters wide) can fit within a single container. The volume of the suspension material in each insulated plastic container can be about 32 cubic meters. This material enters from a pipe connection (not shown in the Figures) to a manifold 26 at the top. Output water from such device using typical MFT from Alberta oil sands tailings ponds could range to more than 50 cubic meters per hour.

When an electric field is established in a saturated soil, a double layer electric flow field is also established. If the soil is very low density, such as in the case of an oil sands tailings suspension, potentially a solids flow field (electrophoresis) could develop before the suspension is dense enough for electro-osmosis to dominate. However, with a relatively clear solution in the electrode covers in the vicinity of the electrodes, or in any interceptor drains, with the application of an electric field, both electrophoretic and electro-osmotic phenomena will be absent and only ions will flow in the solution.

Test 1: Test 1 was carried out in a setup similar to that shown on FIG. 1 in which electrodes 10 and 11 were high conductivity, high electrical capacity composite carbon aerogel electrodes that were each connected to one pole of a direct current electric power supply source that was capable of polarity reversal (not shown). These electrodes were placed in insulated plastic container 12 which also contained a clay-water suspension 13 (diluted Mature Fine Tailings—MFT—from Alberta Oil Sands processing). This is a predominantly Kaolinite and Illite clay mixture.

The clay suspension 13 was placed in container 12 to level 18. Each of the capacitor electrodes 10, 11 were placed inside of a non-woven felt-like fabric cover designated by numerals 14 and 15. Flexible plastic drainage tubes 16 and 17 passed through the wall of container 12 and allowed for drainage of any water entering the electrode covers 14 and 15 to the outside.

In this test, the container 12 had a planar dimension of 16 cm by 16 cm and a height of 10 cm. The electrodes used were 7 cm by 10 cm by 0.5 cm carbon aerogel composite electrodes weighing in the order of 40 grams each. These capacitor electrodes were determined to possess a capacitance of about 40 Farads per gram. The suspension was a sample of Alberta Oil Sands Mature Fine Tailings (MFT) with a water content of about 180% and constituted a very low density clay suspension with a void ratio approaching 4.6. The water wettable, flexible covers 14, 15 with drainage and filtering capabilities were formed into sealed bags with an open top to house the electrodes and were made up of non-woven felt-like polyester fiber geotextiles. These fabrics are marketed as Fine Filter Pad with 100 micron effective opening under Pure-Flo brand of CORALIFE products. The drain tubes were 3.5 mm OD flexible silicon and were about 25 cm long. Carbon aerogel electrodes were placed in the covers and the drains were opened and were allowed to fully drain off. In the number of repetitions of this test, any flow coming out of drain tubes usually stopped within a few minutes. The electric power supply was a Reference 3000 Potentiostat manufactured by GAMRY Instruments Inc. of Pennsylvania, USA. This device can supply up to 3.0 Amperes of current to each capacitor electrode and had a maximum active electrode voltage of +/−6.5 Volts.

The electrodes were positioned near the opposite walls of the container and were connected to potentiostat leads using titanium wire. A potential difference of +6.5 Volts was applied between the two electrodes for 1200 seconds followed by −6.5 Volts for the same duration. This loading cycle was repeated a number of times. Typical currents ranged from 50 to 80 milliamps.

Throughout a number of repetitions of this test the following observations were made: Water flow was always towards the cathode. No water was observed to flow out from the vicinity of the anode. When polarity was reversed and the electrode that was previously the anode became the cathode and the one that was previously the cathode became the anode, the water flow direction also reversed exhibiting drainage towards the cathode. Flow volumes for each 1200 second cycles varied between 6 cubic centimeters to 15 cubic centimeters. The slurry between the two electrodes was observed to be denser towards the electrodes while in the central area of the device, the slurry density appeared to be unchanged.

Test 2: In a number of repetitions of test 1, two interceptor drains were also positioned between the electrodes completely covering the width of the test cell. In testing of these setups it was observed that water flow which had stopped after a few minutes of gravitational drainage, began again after electric current flow was established between the electrodes. The current drop upon operation of these interceptor drains as compared to conditions before their installation was minimal. After these tests it was observed that in addition to clearly observable densification and caking near the electrode and their covers, the same type of suspension caking was easily observable on both sides of the interceptor drains. Caking behaviour and drainage of water out of the interceptor and electrode (cathode) drains upon application of the electric potential difference and establishment of electric current between the electrode clearly confirms that by their use, the flow path length for electro-osmotically flowing water could be shortened, resulting in energy savings.

Based on the above it can be concluded that: (1) Electrophoretic and electro-osmotic processes can be affected capacitively. This allows for benefits of the use of high capacitive electrodes as EDLCs, and eliminates the detrimental aspects of the use of metallic low capacitance electrodes; and (2) Water wettable, flexible layers with drainage and filtering capabilities can be used as covers for the electrodes, and as interceptor drains, to allow for separation of electric and fluid flow fields.

While the present invention has been illustrated by the description of embodiments and examples thereof, it is not intended to restrict or in any way limit the scope of the appended claims to such detail. Additional advantages and modifications will be readily apparent to those skilled in the art. Accordingly, departures may be made from such details without departing from the scope of the invention.

What is claimed is:

1. A method for decontamination and densification of and fluid extraction from a suspension comprising a particulate/liquid dispersion through capacitive electrophoresis and capacitive electro-osmosis processes, the method comprising:
a) receiving an untreated suspension in an insulated container;
b) providing at least one pair of high electric capacitance electrodes spaced apart within the container, wherein the electrodes act as electric double layer capacitors when a potential difference is applied between them;
c) applying a direct current (DC) potential difference between the electrodes to generate an electric field across the suspension to drive capacitive electro-kinetic dewatering, wherein the electric potential developed between each electrode and the adjacent suspension is less than the potential needed to cause occurrence of faradic reactions at the electrodes;
d) reversing the polarity of the DC potential applied to the electrodes upon approach of the initiation of faradic reactions, resulting in the reversal of the electric field direction between electrodes and prevention of faradic reactions at the electrodes; and
e) removing fluid driven from the suspension with at least one outlet drain line.

2. The method of claim 1, wherein the method is operated as either a batch or a continuous process, the method further comprising initially transporting untreated suspension to and receiving untreated suspension within the insulated container, treating the suspension in accordance with claim 1, and thereafter removing the treated suspension from the container.

3. The method of claim 1, the method further comprising providing a cover for each of the electrodes in order to facilitate fluid removal from the location of the electrodes without loss of electric contact between the electrodes and the suspension, each cover comprising a water wettable, flexible fabric with drainage and filtering capability and the capability to pass electric currents when wet.

4. The method of claim 1, the method further comprising providing a plurality of interceptor drains positioned at intervals between the electrodes and within the suspension to allow for drainage of fluid entering the drains while also allowing for passage of electricity through the drains and across the suspension, each interceptor drain comprising a water wettable, flexible fabric with drainage and filtering capability and the capability to pass electric currents when wet.

5. The method of claim 1, wherein the high electric capacitance electrodes are carbon aerogels or carbon aerogel composites.

6. An apparatus for decontamination and densification of and fluid extraction from an untreated suspension comprising a particulate/liquid dispersion through capacitive electrophoresis and capacitive electro-osmosis processes, the apparatus comprising:
a) an insulated container to receive and contain the suspension;
b) at least one pair of high electric capacitance electrodes spaced apart within the container, wherein the electrodes act as electric double layer capacitors to generate an electric field when applying a potential difference there across and hence across the suspension to drive capacitive electro-kinetic dewatering; and
c) at least one outlet drain line to enable removal of fluid driven from the suspension.

7. The apparatus of claim 6, further comprising a direct current (DC) power supply capable of polarity reversal and connected to the electrodes to generate electric field between the electrodes in one direction or the other.

8. The apparatus of claim 6, further comprising a cover for each of the electrodes, each of the covers comprising a water wettable, flexible fabric with drainage and filtering capability and the capability to pass electric currents when wet, wherein the covers facilitate fluid removal from the location of the electrodes without loss of electric contact between the electrodes and the suspension.

9. The apparatus of claim 6, further comprising at least one interceptor drain comprising a water wettable, flexible fabric with drainage and filtering capability and the capability to pass electric currents when wet, wherein the at least one interceptor drain is positioned between the electrodes and within the suspension to allow for drainage of fluid entering the interceptor drain while also allowing for passage of electricity through the interceptor drain and across the suspension.

10. The apparatus of claim 9, comprising a plurality of interceptor drains positioned at intervals between the electrodes and within the suspension.

11. The apparatus of claim 6, wherein the capacitor electrodes are carbon aerogels or carbon aerogel composites.

12. The apparatus of claim 6, further comprising inlet means for delivery of the suspension into the apparatus and between the electrodes, and outlet means for exit of the suspension from the apparatus.

13. An apparatus for capacitive electrophoretic and capacitive electro-osmotic removal of fluids from an electro-active suspension, the apparatus comprising:
a) an insulated container to receive and contain the suspension;
b) at least one pair of high electric capacitance electrodes spaced apart within the container, wherein the high electric capacitance electrodes act as electric double layer capacitors to generate an electric field when applying a potential difference there across and hence across the suspension to drive capacitive electro-kinetic dewatering;
c) at least one outlet drain line to enable removal of fluid driven from the suspension;
d) at least one interceptor drain comprising a water wettable, flexible fabric with drainage and filtering capability and the capability to pass electric currents when wet, wherein the at least one interceptor drain is positioned between the electrodes and within the suspension to allow for drainage of fluid entering the interceptor drain while also allowing for passage of electricity through the interceptor drain and across the suspension;
e) a direct current (DC) power supply capable of polarity reversal and connected to the electrodes to generate electric field between the electrodes in one direction or the other; and
f) a cover for each of the electrodes, each of the covers comprising a water wettable, flexible fabric with drainage and filtering capability and the capability to pass electric currents when wet, wherein the covers facilitate fluid removal from the location of the electrodes without loss of electric contact between the electrodes and the suspension.

14. The apparatus of claim 13, comprising a plurality of interceptor drains positioned at intervals between the electrodes and within the suspension.

15. The apparatus of claim 13, wherein the capacitor electrodes are carbon aerogels or carbon aerogel composites.

16. The apparatus of claim 13, further comprising inlet means for delivery of the suspension into the apparatus and between interceptor drains and electrodes, and outlet means for exit of the suspension from the apparatus.
